(19) United States
(12) Patent Application Publication
(10) Pub. No.: US 2021/0081430 A1
(43) Pub. Date: Mar. 18, 2021

(54) SYSTEM AND METHOD FOR MANAGING A ROLE-BASED BLOCKCHAIN NETWORK

(71) Applicant: Insolar Technologies GmbH, Steinhausen (CH)

(72) Inventors: Kirill Ivkushkin, Moscow (RU); Vladimir Stepanov, Moscow (RU); Pavel Kirillov, Moscow (RU); Andrei Zhulin, Moscow (RU)

(21) Appl. No.: 17/014,043

(22) Filed: Sep. 8, 2020

Related U.S. Application Data
(60) Provisional application No. 62/901,388, filed on Sep. 17, 2019.

(51) Int. Cl. G06F 16/27; G06F 16/23

(52) U.S. Cl. CPC G06F 16/27; G06F 16/2365

(57) ABSTRACT

Disclosed herein are systems and method for managing a blockchain network. In one aspect, a method may pseudo-randomly select, at a start time of an object processing cycle, a first node and a second node from a plurality of nodes in the blockchain network. The method may assign the first node to be a virtual executing node configured to perform a calculation on an object on the blockchain network. The method may assign the second node to be a light material executing node configured to store a result of the calculation performed by the virtual executing node. The method may then, subsequent to an end time of the object processing cycle, assign, from the plurality of nodes, a subset of nodes as the virtual validating nodes configured to validate the calculation result.

### CROSS-REFERENCE TO RELATED APPLICATIONS

This application claims the benefit of U.S. Provisional Application No. 62/901,388, filed Sep. 17, 2019, which is herein incorporated by reference.

### FIELD OF TECHNOLOGY

The present disclosure relates generally to the field of blockchain technology, more specifically, to systems and methods for managing a role-based blockchain network.

### BACKGROUND

Conventional blockchain networks feature a structure in which all nodes request, process, validate, and store the same data. This proves to be highly inefficient because the computing power of all nodes is utilized only to perform redundant data operations. In networks with millions of clients, a structure requiring all nodes to repeat calculations can be resource-intensive and time consuming. The structure used in conventional blockchain networks thus becomes a bottleneck that brings about scalability and throughput issues. Because the number of users and amount of data on blockchain networks is increasing as the technology is being widely adopted to perform a variety of tasks, there is a need for a structure that promotes scalability (e.g., linear scalability) such that the complexity of conventional blockchain networks (e.g., of the order N² or higher) is greatly reduced.

### SUMMARY

To address the shortcomings of conventional blockchain networks, aspects of the present disclosure describe methods and systems for managing a role-based blockchain network.

In one exemplary aspect, a method may pseudo-randomly select, at a start time of an object processing cycle, a first node and a second node from a plurality of nodes in a blockchain network managing a distributed ledger. The method may assign the first node to be a virtual executing node configured to perform a calculation on an object on the distributed ledger. The method may assign the second node to be a light material executing node configured to store a result of the calculation performed by the virtual executing node. The method may, subsequent to an end time of the object processing cycle, determine, based on a risk level of the calculation, a number of nodes to assign as virtual validating nodes configured to verify the result stored on the light material executing node. Furthermore, the method may assign, from the plurality of nodes, a subset of nodes as the virtual validating nodes, wherein a size of the subset equals the number of nodes.

In some aspects, prior to the start time of the object processing cycle, a respective static role is assigned to each of the plurality of nodes when each node is registered into the blockchain network, wherein the respective static role is one of: (1) virtual, (2) light material, and (3) heavy material. Accordingly, the first node is assigned a virtual role and the second node is assigned a light material role.

In some aspects, the method may increase a network throughput and cache size of the blockchain network by assigning the light material role to new nodes being registered and/or existing nodes in the plurality of nodes.

In some aspects, the method may increase a network storage capacity of the blockchain network by assigning a heavy material role to new nodes being registered and/or existing nodes in the plurality of nodes.

In some aspects, the method may increase the network storage capacity specifically in response to determining that a size of the distributed ledger has reached a threshold size.

In some aspects, the method may increase a network compute power of the blockchain network by assigning the virtual role to new nodes being registered and/or existing nodes in the plurality of nodes.

In some aspects, the first node and the second node are not in the subset of nodes.

In some aspects, the object processing cycle is a first object processing cycle, and subsequent to the end time of the first object processing cycle, the method may initiate a second object processing cycle. The method may then select, at a starting time of the second object processing cycle, (1) a third node different from the first node to assign as the virtual executing node and (2) a fourth node different from the second node to assign as the light material executing node.

In some aspects, the method may determine whether the first node completed the calculation by the end time of the first object processing cycle, wherein the first node sends a delegation request to the third node and receives a delegation, from the third node, to be the virtual executing node and continue the calculation in in the second object processing cycle in response to determining that the first node did not complete the calculation by the end time.

In some aspects, subsequent to the light material executing node storing the result, a light material validating node is configured to verify whether the light material executing node is authorized to store the result and whether the result is correctly stored.

In some aspects, the light material executing node is further configured to receive at least one validation request from the subset of nodes, register the at least one validation request, receive at least one validation result from the subset of nodes, and store the at least one validation result.

In some aspects, the light material executing node is further configured to receive and store (cache) records sent by execution nodes and validation nodes. Furthermore, the light material executing node receives and satisfies requests from the executing and validating nodes by sending data (e.g., objects and results) to them.

In some aspects, the light material executing node is further configured to transmit copies of the at least one validation result and the result of the computation to at least one of another light material executing node and a heavy material node in the blockchain network, based on a replication factor, such that the at least one validation result and the result of the computation are not lost if the light material executing node fails.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for managing and storing a distributed ledger of records, according to an exemplary aspect.

FIG. 2 is a block diagram illustrating a plurality of node roles for assignment to nodes in a blockchain network, according to an exemplary aspect.

FIG. 3 is a block diagram illustrating a data object workflow between a plurality of nodes across multiple pulses, according to exemplary aspects of the present disclosure.

FIG. 4 is a flow diagram for object processing using a multi-role model, according to an exemplary aspect.

FIG. 5 is a flow diagram for assigning roles to a plurality of nodes maintaining a distributed ledger, according to an exemplary aspect.

FIG. 6 is a block diagram of a computer system on which the disclosed system and method can be implemented according to an exemplary aspect.

### DETAILED DESCRIPTION

Exemplary aspects are described herein in the context of a system, method, and computer program product for managing a role-based blockchain network. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

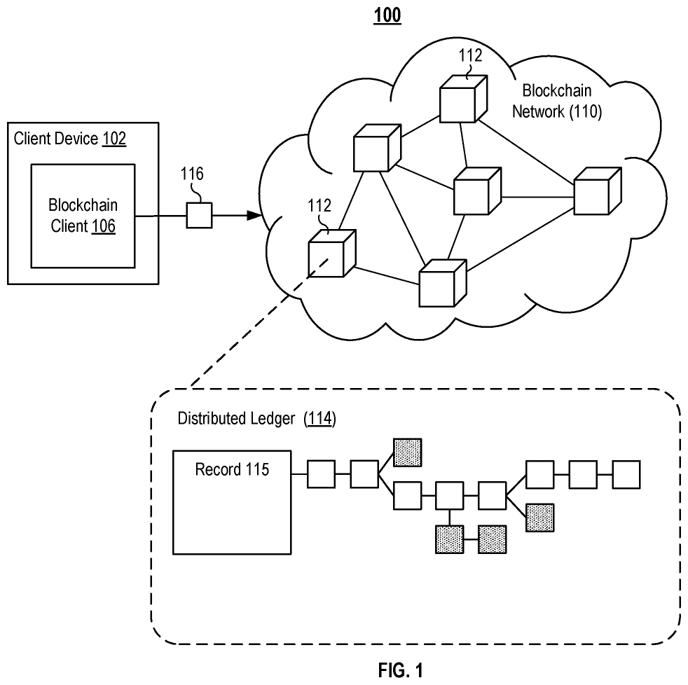

FIG. 1 is a block diagram of a system 100 for maintaining and storing a distributed ledger of records, according to an exemplary aspect. The system 100 may include one or more client device(s) 102 communicatively connected to blockchain network 110. Client device 102 may be one of personal computers, servers, laptops, tablets, mobile devices, smart phones, cellular devices, portable gaming devices, media players or any other suitable devices that can retain, manipulate and transfer data. Client device 102 may include a blockchain client 106, which is a software application configured to generate and transmit one or more blockchain-based transactions or messages 116 to blockchain network 110 for accessing or modifying records stored in the distributed ledger, such as managing user accounts, the transfer of cryptographic assets to and from such user accounts, and other types of operations.

According to an exemplary aspect, blockchain network 110 can be a distributed peer-to-peer network formed from a plurality of nodes 112 (computing devices) that collectively maintain distributed ledger 114, which may contain one or more blockchains 114. For purposes of the present discussion, the terms distributed ledger and blockchain may be interchangeably used. Blockchain 114 is a continuously-growing list of data records hardened against tampering and revision using cryptography and is composed of data structure blocks that hold the data received from other nodes 112 or other client nodes, including the client device 102 executing an instance of the blockchain client 106. The blockchain client 106 is configured to transmit data values to the blockchain network 110 as a transaction data structure 116, and nodes 112 in the blockchain network record and validate/confirm when and in what sequence the data transactions enter and are logged in blockchain 114.

The distributed ledger may be organized into multiple blockchains 114 which are configured to ensure chronological and immutable storage of data. In one aspect, the distributed ledger may include one or more lifeline blockchains, sideline blockchains, and jet blockchains. In one implementation, lifeline blockchains are individual blockchains in which each data object and all its states are stored (i.e., objects are treated as individual blockchains). Lifeline blockchains can have logic and code associated with them, so the terms lifeline blockchain, object, and smart contract may be used interchangeably. In one aspect, sideline blockchains are utility lifeline blockchains used to store temporary or auxiliary data such as indexes, pending operations, or debug logs. A lifeline blockchain can have several associated sideline blockchains to store information. A jet blockchain may be configured to act as a shard or partition which make up storage blocks and form shard chains. Records in a jet blockchain may be first produced by a lifeline blockchain, then packaged into blocks, and placed in sequence to form a chain of blocks. Replication and distribution of data can be managed individually by blocks and jet blockchains. The use of multiple kinds of blockchains enables dynamic reconfiguration of storage by splitting and merging of j et blocks without compromising data immutability.

Distributed ledgers (e.g., blockchain 114) are used to store a plurality of records 115, which may contain information such as a request, a response, a control of state, and maintenance details. In known approaches to blockchain technology, records 115 of a distributed ledger are ordered chronologically by time of creation or registration, and each record of a ledger may represent an operation (or a change) made and can have a reference to a previous record which represents a baseline for the operation. The reference uniquely identifies an entity (e.g., record) and is based on or includes information (e.g., checksum, hash, or signature) to validate the integrity of the entity the reference points to. Blockchain 114 is configured such that record 115 contained in the blockchain contains a reference to a previous record and hash information.

Each record 115 in blockchain 114 is addressed by a hash value and a pulse number, set at a given pulse. Pulses represent a baseline mechanism that is responsible for network synchronization and provides randomness. A pulse is a signal that indicates the beginning of a time interval that lasts a predetermined time period and may be interpreted as a portion of data that carries information about time and randomness. Every pulse is identified by a pulse number that is a unique, monotonically increasing integer. It should be noted that the terms “pulse” and “object processing cycle” are used interchangeably in the present disclosure.

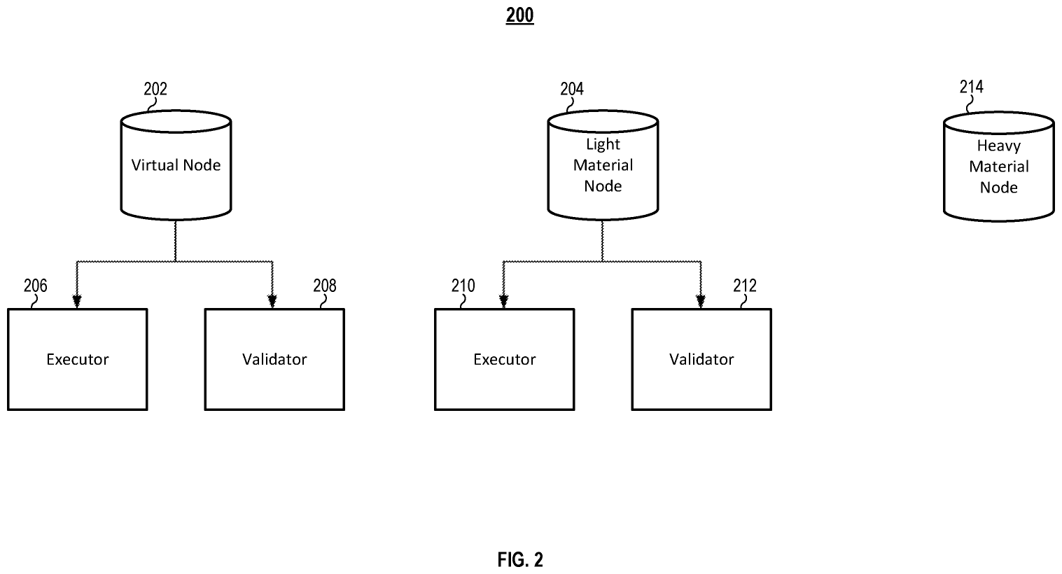

FIG. 2 is block diagram 200 illustrating a plurality of node roles for assignment to nodes 112 in blockchain network 110, according to an exemplary aspect. In exemplary aspects, nodes 112 of network 110 may be assigned static roles and dynamic roles. In some aspects, nodes 112 may be assigned special roles.

Each node 112 has only one static role, which is assigned during node registration (e.g., when the node is added to network 110). The three possible static roles are (1) heavy material, which is specified for long-term data storage, (2) light material, which is specified for short-term data storage of blocks (e.g., record 115), and (3) virtual, which is specified for code execution and short-term storage of objects. An object may be an instance of a smart contract. Objects are represented at the logical storage by a “lifeline” comprising a set of records, wherein each record corresponds to a different state. Static roles cannot overlap (e.g., a given node cannot be both a light material node and a virtual node). As static roles are assigned during node deployment, the assignment implements the principle of separation of powers, which makes it difficult for nodes to collude to spoof or tamper with the data.

Within their static role, individual nodes can be assigned a dynamic role. The two possible dynamic roles are validator and executor. These dynamic roles define the rights and responsibilities of a node in relation to a specific entity such as an object in a specific pulse. One node with a given static role may have different dynamic roles, including several roles for one entity, but across different pulses. For example, a node that has a static role “virtual” may be assigned the dynamic role “virtual validator” for an object A in pulse N. The task of a virtual validator node is to check the correctness of the calculation that a virtual executor node performed for object A in the previous pulse N−1. If one needs to enhance operation security, the number of validating nodes may be increased for a particular object or for a particular business operation. A node with a static role “virtual” can be a “virtual executor” or a “virtual validator” for object A, but not both in the same pulse. Dynamic roles may be assigned within static roles (e.g., there can be a virtual executor, light material validator, etc.). Because both static and dynamic roles are supported at both the compute layer and the storage layer of the blockchain and those layers do not overlap, there is added security when performing operations.

In terms of special roles, a subset of nodes 112 in network 110 may be given special permissions not associated with static roles. A node can have zero or more roles of this type, assigned when registering a node. “Discovery” is an example of a special role. A discovery node is a node used to connect nodes 112 to network 110 with an irrelevant list of active nodes.

In some aspects, as shown in FIG. 2, each node 112 in blockchain network 110 may either be a virtual node 202, a light material node 204, or a heavy material node 214 in terms of static role during node registration. As discussed previously, virtual node 202 may be one of two dynamic role nodes: virtual executor node 206, which is a node that executes calculations and outputs results, and virtual validator node 208, which is a node that validates the output of executor 206. Virtual nodes are able to introduce object state changes as new data into storage. Virtual nodes are stateless and do not need data recovery, allowing for easy assignment to make a node in blockchain network 110 into a virtual node. For any particular operation on any particular object, a virtual node may be allocated as an executor node or a validator node. Virtual executor nodes perform calculations and pass the results for registration to the light material executor nodes after validation is performed by virtual validator nodes. A calculation may involve creating a new object or a new state of an existing object. Specifically, virtual nodes may receive and handle requests to execute contracts, read the latest contract states, generate updates (e.g., new records), and handle contract-related data encryption.

Light material nodes represent short-term storage as they do not store data indefinitely and may remove data once a predetermined amount of time, as measured in object processing cycles, has elapsed. Light material nodes may replicate storage blockchain blocks among each other, thus ensuring adjustable replication factor such that a malfunction of a certain amount of light material nodes does not disrupt service. The dynamic roles of light material node 204 are also split into two categories: material executor node 210, which stores data that is accessed frequently (e.g., functioning as a cache for heavy material nodes 214), and material validator node 212, which determines whether material executor node 210 was indeed authorized to perform the material executor role (e.g., to perform light execution such as storage during a given object processing cycle) and if so, determines whether the storing operation has been completed successfully. Light material executor nodes specifically register incoming requests from virtual executor nodes and register the results associated with the incoming requests (subsequent to validation by light material validator nodes). Light material executor nodes are responsible for storing data and providing it on request to virtual executor nodes. Each material node is responsible for its own objects (determined by the object's hash), with each object assigned its own virtual node and light material node. Material nodes cannot create or modify data by themselves; they work solely with smart contract states received from the virtual nodes.

Heavy material node 214 is a static role node that performs long term data storage. Light material nodes store state changes of objects for certain adjustable amounts of object processing cycles (pulses), so that frequently accessed objects remain cached. Objects that are not used for at least a pre-defined number of object processing cycles after access are stored on heavy material nodes only. Heavy material nodes complete long-term distributed storage with data replication, scattering controls, and automated content integrity checks. For example, heavy material nodes may replicate data among each other, thus ensuring adjustable replication factor indicative of the number of nodes that should keep a copy of certain data. In some aspects heavy material nodes also may ensure an adjustable scattering factor so that data for a particular object does not get accumulated in full on any particular node and is distributed (scattered) across several heavy material nodes (this provides additional security against data compromise). A network without replication and scattering may only have a single heavy material node. Because light material nodes are a fast cache above heavy material nodes, a virtual node may send data requests to light material nodes rather than to heavy material nodes. Accordingly, when additional records 115 are created in blockchain 114, there is a greater need for light material nodes to retrieve information more quickly and thus increase the object processing speed of network 110.

Unlike the traditional structure of blockchain networks in which all nodes perform the same tasks and calculations, the assignment of roles to the nodes encourages scalability through increased throughput and increased storage. For example, increasing the number of virtual nodes provides higher CPU throughput because a greater number of nodes are dedicating their processing to perform calculations. Increasing the number of light material nodes provides higher network throughput because a greater number of nodes can quickly provide objects and register results. Increasing the number of heavy material nodes, which store full history of objects state changes, increases storage capacity because a greater number of nodes are dedicating themselves to providing storage. For example, when a new node is to be registered in network 110, depending on the needs of the network, a static role and dynamic role can be selected for the new node. If the size of the distributed ledger has reached a threshold size (e.g., 30 GB), the new node may be assigned as a heavy material node. Alternatively, if the amount of time to retrieve objects exceeds a threshold period of time (e.g., causing at least a threshold number of calculations to last beyond a given object processing cycle), the throughput of the network may be low and improving cache size may remedy the issue. Thus, the new node may be assigned as a light material node. Alternatively, if the amount of calculations to be performed per processing cycle exceeds the number of virtual nodes, increasing the compute power of the network may be necessary. Thus, the new node is assigned as a virtual node. In some aspects, the static and dynamic roles can be changed based on the necessities described above.

In terms of dynamic roles, adding virtual validators scales the validation of executable requests, and adding virtual executors scales the request execution speed. Thus, by redistributing dynamic roles, the computing performance of a distributed network including for different objects or requests can be adjusted.

Although in the absence of heavy material nodes, light material nodes can support long-term storage through enhanced persistence of cached data, splitting light and heavy material nodes offers various benefits. Firstly, the split offers storage reliability through configurable redundancy because data is distributed across multiple nodes according to a replication factor. In the event of a node failure, there are other copies which ensure configurable service level agreements (SLAs) against data loss. Second, the split enables better configuration of network 110 as discussed above. For example, if network 110 requires improved throughput capacity scaling, the number of light material nodes can be adjusted. If network 110 requires improved storage capacity scaling, the number of heavy material nodes can be adjusted. Thus, depending on the needs of network 110, performance can be optimized through the splitting of roles.

In some aspects, the configuration settings for the distribution and redundant storage of data is provided by a replication protocol of material nodes. In some aspects, one of the participants in the replication protocol can be external to the blockchain network 110 (e.g., such as an observer-node block network, which is a read-only Online Analytical Processing (OLAP) system). In some aspects, network 110 may comprise nodes that do not perform computations and data processing, but support network 110 and can perform auxiliary functions such as distributing software updates, monitoring health status, connecting new nodes, providing Online Transactional Processing (OLTP) and OLAP services.

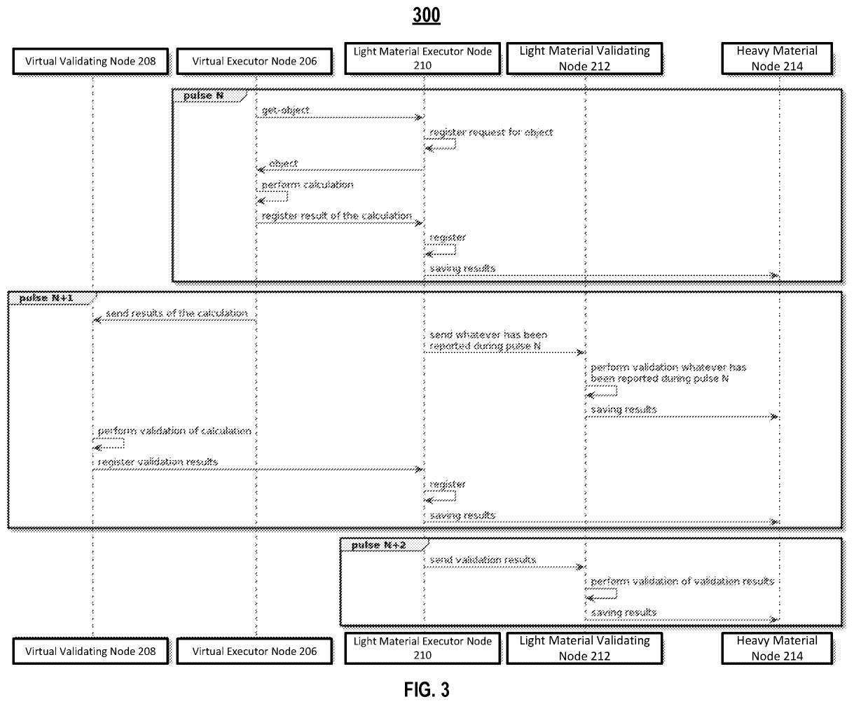

FIG. 3 is a block diagram of data object workflow 300 between a plurality of nodes across multiple pulses, according to exemplary aspects of the present disclosure. For each calculation, nodes 206, 208, 210, and 212 are pseudo-randomly assigned without relying on a central authority. As depicted, virtual executor node 206 may send a call message requesting an object to light material executor node 210. In order to identify light material executor node 210, virtual executor node 206 may utilize a function such as node=get_node(“role”, object, pulse_data) that can be used to search for and identify nodes in network 110. In this function, the role is indicative of “virtual executing,” “virtual validating,” “material executing,” “material validating,” etc. The object field in the function comprises an identifier of the object (e.g., a hash value of the object). The pulse data field in the function is indicative of a particular object processing cycle (e.g., N, N+1, etc.). In response to receiving the call message, light material executor node 210 may register the processing request and send the stored object to virtual executor node 206. Using the object data, virtual executor node 206 may perform calculations on the object. Once this has happened, light material validating node 212 may validate whether light material executor node 210 was supposed to fulfill the role of the material executor and determines whether the registering/storing of the processing request was performed successfully.

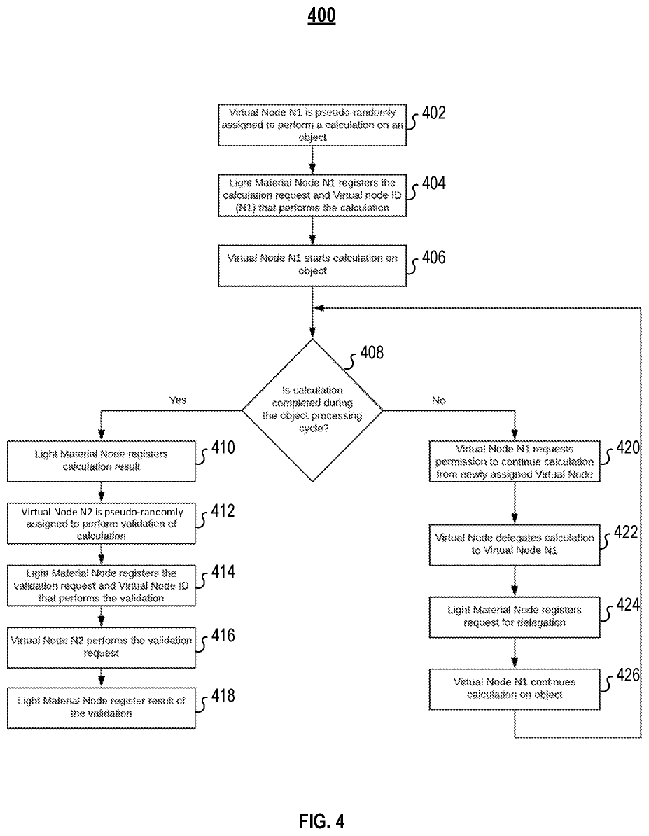

Upon completion of the calculation, which may take place during the same pulse or a subsequent pulse (discussed in FIG. 4), virtual executor node 206 may send another call message to light material executor node 210 to store the object's modification records. The modifications may be in serialized fields (attributes) of a smart contract instance (e.g., the type of the smart contract, the hash of the previous record, pulse data, etc.). Light material executor node 210 may then add the modification record to the ledger (e.g., blockchain 114). For example, light material executor node 210 may receive a notification that processing of virtual executor node 206 has been completed. Light material executor node 210 may register that processing has been completed and may also register the result. Light material validating node 212 may again proceed to validate whether light material executor 210 was supposed to fulfill the role of the material executor and determines whether the registering/storing was performed successfully. For the purpose of explaining the process, the diagram shows the transmission of data to the heavy material node is shown in the same pulse.

In a high-level overview, during the next pulse (e.g., pulse N+1), virtual node 208 becomes a virtual validating node 208 (described further in FIG. 4) and performs a validation of the calculation performed by virtual executor node 206. The validation result is transmitted to light material executor node 210, which registers the result. In some aspects, light material validating node 212 may validate this registration as well.

In some aspects, the object and the modification records of the objects may be accessed by various virtual nodes over several pulses. Accordingly, the records and the object are kept stored in light material executor node 210 for quick access. Suppose that the object is not accessed for at least M pulses. M may represent a threshold number of pulses before an un-accessed object is transferred to a heavy material node. Thus, at pulse N+M, the object and the modification record(s) are transferred to heavy material node 214 and removed from storage in light material executor node 210.

FIG. 4 is a flow diagram for method 400 for object processing using a multi-role model, according to an exemplary aspect. At 402, virtual node N1 (e.g., virtual executor node 206) is pseudo-randomly assigned to perform a calculation on an object. At each operation, data detailing the calculations occurring on an object and which nodes are processing the calculation is registered and stored in a light material node assigned to the object. Accordingly, at 404, light material node N1 (e.g., light material executor node 210) registers the calculation request and the virtual node ID of virtual node N1. Furthermore, in some aspects, light material validating node 212 may verify the rights of light material executor node 210 and whether the registration has been properly performed. At 406, virtual node N1 starts calculation on the object.

At 408, a determination is made on whether the calculation has been completed during the object processing cycle (i.e., whether the time period set for object processing has elapsed despite an ongoing calculation). In response to determining that the calculation has been completed, method 400 proceeds to 410, where light material node N1 registers the calculation result. In some aspects, light material validating node 212 may again verify the rights of light material executor node 210 and whether the registration has been properly performed.

At 412, virtual node N2 (e.g., virtual validating node 208) is pseudo-randomly assigned to perform validation of the calculation. It should be noted that following the end of the time period set for object processing, new virtual node(s) are assigned pseudo-randomly to validate the calculation. The pseudo-random role assignment prevents a node from predicting its role during the object processing cycle. The number of virtual nodes to validate can be set in accordance with a certain rule or set of rules. For example, the rules may depend on the value of the transaction and the level of risk at stake, wherein risk can be offset by adding more validator nodes. The risk level is a predetermined value set by a stakeholder and is indicative of the importance of a calculation to the stakeholder. For example, the risk level may be a quantitative (e.g., an integer or percentage) or qualitative value (e.g., “low,” “medium,” and “high”). If a particular calculation is highly important to a stakeholder (due to the parties involved in the transaction or the size of the transaction), the calculation is riskier because there would be greater motivation to tamper with the calculation and attempt fraud. For example, if the risk level may be a value between 1 and 10 or 1% to 100%. A value such as 1 or 1% may indicate that the calculation is not at all risky, while a value such as 10 or 100% may indicate that the calculation has a maximum risk associated with it. A stakeholder may provide a risk level such as 6 in a transaction. Based on this, the number of validating nodes will be selected. In some aspects, the number is proportional to the risk level. For example, a risk level of 1 may be associated with a single validating node, while a risk level of 6 may be associated with six validating nodes. More specifically, in terms of determining a number of validating nodes, rules that evaluate the risk level may be used. For example, a rule may indicate that at least X number of validating nodes (e.g., 10 nodes or 10% of nodes in network 110) are required for a risk level of 10%.

In some aspects, if the risk level is not already provided by a stakeholder of the calculation, the risk level may be determined as a function of the size of the transaction, the number of stakeholders, the valuation of a stakeholder (e.g., as more well-known and wealthy parties would be targeted by fraud), etc. The blockchain network may refer to a table that indicates risk levels based on a plurality of attributes. An exemplary table may be:

| Size | Stakeholder | Valuation | Risk Level |
|---|---|---|---|
| <50 virtual currency | Company X | 200.13 USD | low |
| <100 virtual currency | Company X | 200.13 USD | medium |
| >100 virtual currency | Company X | 200.13 USD | high |

As can be seen, for a particular stakeholder, the size of the transaction (e.g., the amount of virtual currency at stake) may dictate risk level. Likewise, for different stakeholders and the number of stakeholders for a particular blockchain, the risk level may be different. It should be noted that risk level may also change over time as the number of stakeholders change and the valuation changes. In some aspects, in addition to the amount of validating nodes, the type of validation may also be determined based on the risk level. Should an operation have little value to a stakeholder of a calculation (and therefore, a lower risk level) validation may be restricted to only checking the basic consistency of a composed blockchain. In terms of basic consistency, a validating node may determine whether the particular executing node had the “executor” role for the object and whether calculation result determined by the executing node is correct. If the risk level is great (e.g., greater than a threshold set by a stakeholder such as “medium”), the validating node(s) may perform additional actions such as determining proof of stake (PoS) between network participants (members of a domain) or performing an “all-or-nothing” (i.e. all validating nodes must confirm) scheme of voting. In some aspects, the validating nodes may not know any details of which additional actions are engaged and may simply perform the code to validate the correctness of the results.

At 414, light material node N1 registers the validation request and the virtual node ID of virtual node N2, which performs the validation of the calculation. In some aspects, light material validating node 212 may validate the rights of light material node N1 and whether the registration was performed correctly. At 416, virtual node N2 performs the validation request. At 418, light material node N1 registers the result of the validation. In some aspects, light material validating node 212 may again validate the rights of light material node N1 and whether the registration was performed correctly. If it is determined that the calculation is invalid, the respective nodes may mark and store the result as “invalid.” This marker can be used for identifying whether to roll back a transaction or perform storage optimizations.

Returning to 408, if a determination is made that the calculation has not been completed by the end of the object processing cycle, method 400 proceeds to 420, where virtual node N1 requests permission to continue the calculation from a newly assigned virtual node N3 (e.g., a different virtual executor node). In other words, if a virtual node N1 is unable to complete its calculations for a particular request on a particular object by the end of the object processing cycle (e.g., due to delays in retrieving data or due to the request involving a particularly large or complex calculation of data), virtual node N1 informs the virtual node assigned as the new calculation node at the beginning of the next object processing period that it has been unable to complete its calculations. At 422, the newly assigned virtual node N3 delegates the calculation to virtual node N1. At 424, light material node N1 registers the request for delegation. At 426, virtual node N1 continues calculation on the object. Method 400 then returns to 408 and loops between 408 and 426 until the calculation is complete.

This mechanism is necessary to prevent a backlog of incomplete calculations and ensures that each request is processed. Because every newly assigned virtual node would have to begin calculations from scratch, this allows for the initial virtual node N1, which has already begun work on the calculation, to complete the calculation without wasting computing resources.

In some aspects, at the end of each object processing cycle, the light material nodes pass the information about requests and data to heavy material nodes.

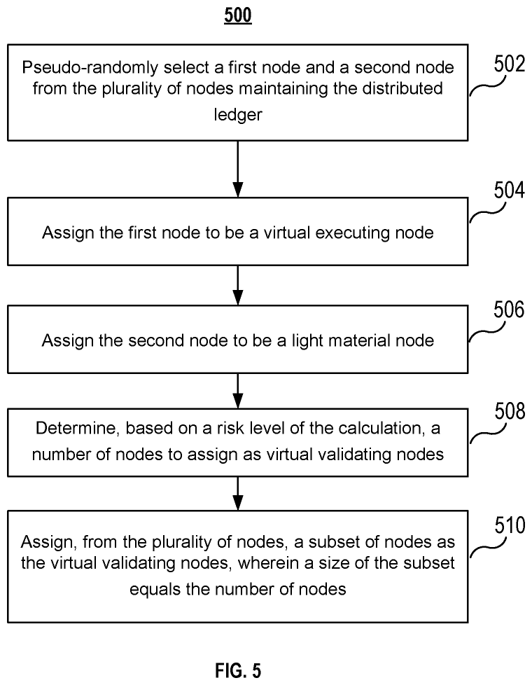

FIG. 5 is a flow diagram for method 500 for assigning roles to a plurality of nodes maintaining a distributed ledger, according to an exemplary aspect. Method 500 begins at 502, where a first node and a second node are pseudo-randomly selected from the plurality of nodes maintaining the distributed ledger at a start time of an object processing cycle. In some aspects, prior to the start time of the object processing cycle, a respective static role is assigned to each of the plurality of nodes when each node is registered into the network. Accordingly, the first node may already be a virtual node and the second node may already be a light material node. Step 502 is therefore performed to identify dynamic roles of the nodes.

At 504, the first node is assigned to be a virtual executing node configured to perform a calculation on an object on the distributed ledger. At 506, the second node is assigned to be a light material executing node configured to register a result of the calculation performed by the virtual executing node.

At 506, subsequent to an end time of the object processing cycle, a determination is made, based on a risk level of the calculation assigned by a user (e.g., a business foundation or stakeholder), of a number of nodes to assign as virtual validating nodes configured to verify the result stored on the light material node.

Method 500 ends at 510, where a subset of the plurality of nodes is assigned as the virtual validating nodes, wherein a size of the subset equals the number of nodes.

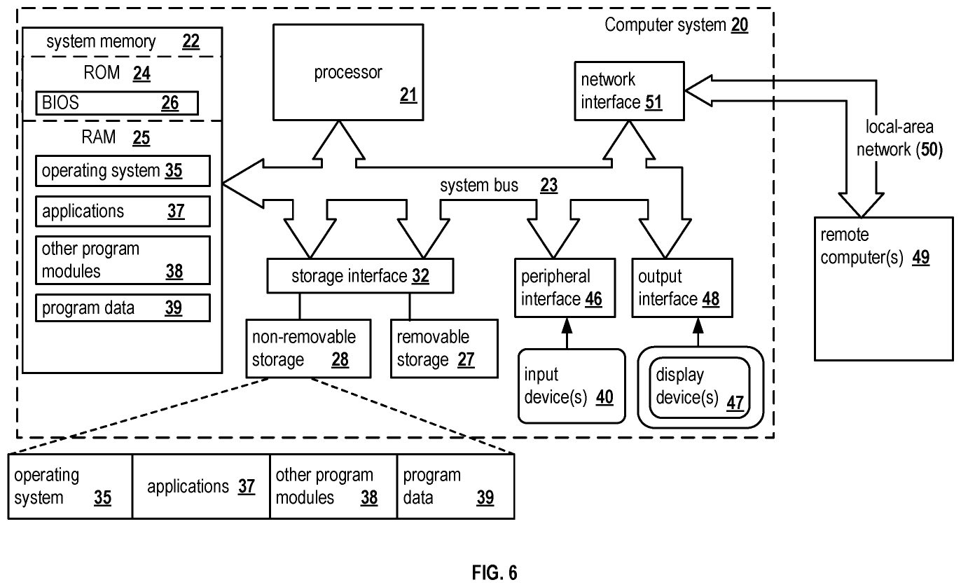

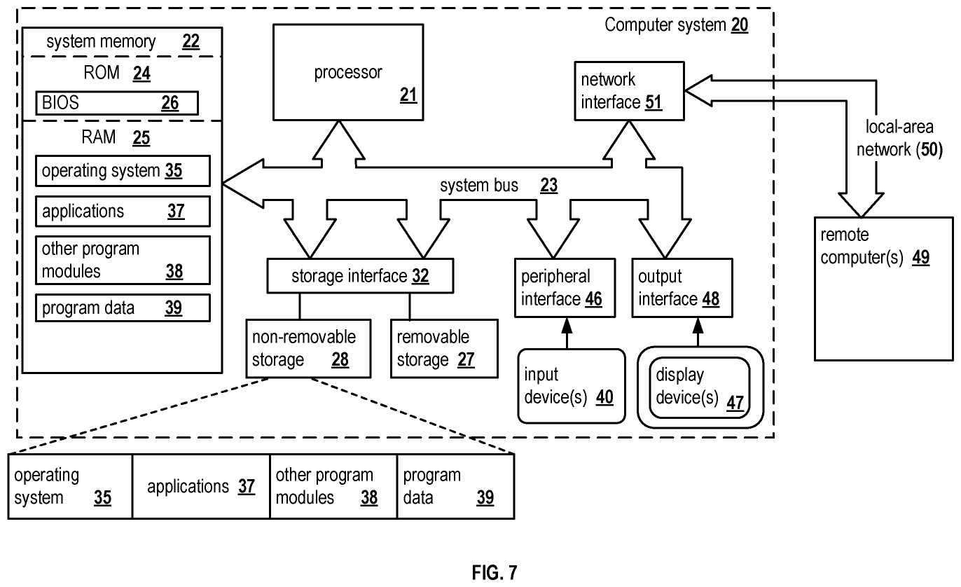

FIG. 6 is a block diagram illustrating a computer system 20 on which aspects of systems and methods for assigning roles to a plurality of nodes managing a distributed ledger and registering modifications to a record on a distributed ledger using a multi-role model may be implemented in accordance with an exemplary aspect. It should be noted that the computer system 20 could correspond to the client device 102, for example, described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, Hyper Transport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 6, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for managing a blockchain network, the method comprising:
pseudo-randomly selecting, at a start time of an object processing cycle, a first node and a second node from a plurality of nodes in the blockchain network;
assigning the first node to be a virtual executing node configured to perform a calculation on an object on the blockchain network;
assigning the second node to be a light material executing node configured to store a result of the calculation performed by the virtual executing node;
determining a risk level of the performed calculation;
subsequent to an end time of the object processing cycle, determining, based on the risk level of the calculation, a number of nodes to assign as virtual validating nodes configured to verify the result of the calculation stored on the light material executing node; and
assigning, from the plurality of nodes, a subset of nodes as the virtual validating nodes, wherein a size of the subset equals the determined number of nodes.

2. The method of claim 1, wherein prior to the start time of the object processing cycle, a respective static role is assigned to each of the plurality of nodes when each node is registered into the blockchain network, wherein the respective static role is one of: (1) virtual, (2) light material, and (3) heavy material, and
wherein the first node is assigned a virtual role and the second node is assigned a light material role.

3. The method of claim 2, further comprising:
increasing a network throughput and cache size of the blockchain network by assigning the light material role to new nodes being registered and/or existing nodes in the plurality of nodes.

4. The method of claim 2, further comprising:
increasing a network storage capacity of the blockchain network by assigning a heavy material role to new nodes being registered and/or existing nodes in the plurality of nodes.

5. The method of claim 4, wherein increasing the network storage capacity is in response to determining that a size of a distributed ledger managed by the blockchain network has reached a threshold size.

6. The method of claim 2, further comprising:
increasing a network compute power of the blockchain network by assigning the virtual role to new nodes being registered and/or existing nodes in the plurality of nodes.

7. The method of claim 1, wherein the first node and the second node are not in the subset of nodes.

8. The method of claim 1, wherein the object processing cycle is a first object processing cycle, further comprising:
subsequent to the end time of the first object processing cycle, initiating a second object processing cycle;
selecting, at a starting time of the second object processing cycle, (1) a third node different from the first node to assign as the virtual executing node and (2) a fourth node different from the second node to assign as the light material executing node.

9. The method of claim 8, further comprising:
determining whether the first node completed the calculation by the end time of the first object processing cycle, wherein the first node sends a delegation request to the third node and receives a delegation, from the third node, to be the virtual executing node and continue the calculation in in the second object processing cycle in response to determining that the first node did not complete the calculation by the end time.

10. The method of claim 1, wherein subsequent to the light material executing node storing the result, a light material validating node is configured to verify whether the light material executing node is authorized to store the result and whether the result is correctly stored.

11. The method of claim 1, wherein the light material executing node is further configured to:
receive and store (1) validation requests from the subset of nodes and (2) object requests from the virtual executing node; and
provide data satisfying the validations requests and object requests.

12. The method of claim 11, wherein the light material executing node is further configured to transmit copies of the at least one validation result and the result of the calculation to at least one of another light material executing node and a heavy material node in the blockchain network, based on a replication factor, such that the at least one validation result and the result of the calculation are not lost if the light material executing node fails.

13. A system for managing a blockchain network, the system comprising:
a hardware processor configured to:
pseudo-randomly select, at a start time of an object processing cycle, a first node and a second node from a plurality of nodes in the blockchain network;
assign the first node to be a virtual executing node configured to perform a calculation on an object on the blockchain network;
assign the second node to be a light material executing node configured to store a result of the calculation performed by the virtual executing node;
subsequent to an end time of the object processing cycle, determine, based on a risk level of the calculation, a number of nodes to assign as virtual validating nodes configured to verify the result stored on the light material executing node; and
assign, from the plurality of nodes, a subset of nodes as the virtual validating nodes, wherein a size of the subset equals the number of nodes.

14. The system of claim 13, wherein prior to the start time of the object processing cycle, a respective static role is assigned to each of the plurality of nodes when each node is registered into the blockchain network, wherein the respective static role is one of: (1) virtual, (2) light material, and (3) heavy material, and
wherein the first node is assigned a virtual role and the second node is assigned a light material role.

15. The system of claim 14, wherein the hardware processor is further configured to:
increase a network throughput and cache size of the blockchain network by assigning the light material role to new nodes being registered and/or existing nodes in the plurality of nodes.

16. The system of claim 14, wherein the hardware processor is further configured to:
increase a network storage capacity of the blockchain network by assigning a heavy material role to new nodes being registered and/or existing nodes in the plurality of nodes.

17. The system of claim 16, wherein the hardware processor is further configured to increase the network storage capacity in response to determining that a size of a distributed ledger managed by the blockchain network has reached a threshold size.

18. The system of claim 14, wherein the hardware processor is further configured to:
increase a network compute power of the blockchain network by assigning the virtual role to new nodes being registered and/or existing nodes in the plurality of nodes.

19. The system of claim 13, wherein the first node and the second node are not in the subset of nodes.

20. A non-transitory computer readable medium storing thereon computer executable instructions for managing a blockchain network, including instructions for:
pseudo-randomly selecting, at a start time of an object processing cycle, a first node and a second node from a plurality of nodes in the blockchain network;
assigning the first node to be a virtual executing node configured to perform a calculation on an object on the blockchain network;
assigning the second node to be a light material executing node configured to store a result of the calculation performed by the virtual executing node;
subsequent to an end time of the object processing cycle, determining, based on a risk level of the calculation, a number of nodes to assign as virtual validating nodes configured to verify the result stored on the light material executing node; and
assigning, from the plurality of nodes, a subset of nodes as the virtual validating nodes, wherein a size of the subset equals the number of nodes.
